(19) United States
(12) Patent Application Publication
(10) Pub. No.: US 2021/0320938 A1
(43) Pub. Date: Oct. 14, 2021

(54) NETWORK SECURITY ENFORCEMENT DEVICE

(71) Applicant: CSP, INC., Lowell, MA (US)

(72) Inventors: Timothy F. OBER, Atkinson, NH (US); Gary S. SOUTHWELL, Chelmsford, MA (US)

(21) Appl. No.: 17/285,308

(22) PCT Filed: Nov. 7, 2018
(86) PCT No.: PCT/US2018/059550

§ 371 Date: Apr. 14, 2021

Related U.S. Application Data
(60) Provisional application No. 62/583,252, filed on Nov. 8, 2017.

(51) Int. Cl. H04L 29/06; G06F 9/455

(52) U.S. Cl. CPC H04L 63/1425; H04L 63/1416; H04L 63/20; G06F 2009/45587; G06F 9/45558; G06F 2009/45595; H04L 63/0245

(57) ABSTRACT

A software defined security (SDS) solution provides a centralized approach to security deployment across an entire enterprise infrastructure. Modern virtualization approaches serve to separate the physical machine, or server, from the operating system and applications that run on it. A robust security approach implements a security container deployable on various computing entities, whether defined by a hypervisor, container or dedicated operating system. Protected applications launch in an execution environment that may be virtualized, yet is protected by the container deployed on the computing entity on which it resides. The security containers identify, for each computing entity, available security resources, and apply these resources to throughput data of the computing entity. Each of the security containers is responsive to a resource manager, which implements a network policy through the security containers. The network policy defines logic that scrutinizes the ingress and egress traffic for compliance, and disallows and/or reports deviations.

### BACKGROUND

Computer network security has becoming an increasingly compelling concern for corporate and individual users alike. Media attention to data breaches of corporate repositories, and the resulting liability, has resulted in computer security, or so-called “cybersecurity,” to become a requirement of sound business practices. In a highly connected enterprise, having multiple sites and telecommuting employees, the reach of the corporate computing infrastructure can be substantial, however any weak point in this infrastructure potentially compromises the entire network.

### SUMMARY

A software defined security (SDS) solution provides a centralized approach to security deployment across an entire enterprise infrastructure. Modern virtualization approaches serve to separate the physical machine, or server, from the operating system and applications that run on it. Implementation of aspects such as virtual machines, hypervisors, and containers compartmentalize operating systems and running environments such that the physical machine no longer binds applications to an execution platform. A robust security approach implements a security container deployable on various computing entities, whether defined by a hypervisor, container or dedicated operating system. Protected application entities (apps) launch in an execution environment that may be virtualized, yet is protected by the container deployed on the computing entity on which it resides. The security containers identify, for each computing entity, available security resources, and apply these available resources to ingress and egress data of the computing entity. Each of the security containers is responsive to a resource manager, which implements a network policy through the security containers. The network policy defines logic that, when implemented by the security container, scrutinizes the ingress and egress traffic for compliance, and disallows and/or reports deviant transmission attempts.

Conventional network security relies on an interconnection of separate, network conversant computing devices. In order to maintain security of data passed between the computing devices, it is typical to employ some type of security measures on each computing device. Typically this is done at a network interface, such as an Ethernet network interface card (NIC) on each machine, or at a network ingress/egress point for a group of computing devices in close proximity such as a building, site or enterprise campus. Configurations herein are based, in part, on the observation that a network security policy (policy) is often developed and prescribed for a group of interconnected network computers. It is expected that the policy is implemented on each computing device in the most appropriate manner Often, this may entail decentralized and/or manual configuration on a number of computing devices and network access (ingress/egress) points, such as routers and switches.

Unfortunately, conventional approaches suffer from the shortcoming that it can be problematic to ensure consistent implementation across all computing devices in a network supporting an enterprise environment. Varying degrees of automation, combined with different platforms and security product availability for each computing device, can make it difficult to enforce widespread compliance with the network security policy. Accordingly, configurations herein substantially overcome the above described shortcomings by instantiating a software defined security (SDS) instantiation across each computing entity within the network to which the policy applies. A resource manager identifies the network entities to which the policy should extend, and instantiates or invokes a security entity that best protects the network entity. The security entity may be an instantiation of a software container, a virtual machine (VM) or an invocation of a hardware interface card. Each security entity is provided with policy logic for implementing the network security policy in a consistent and verifiable manner across the interconnected computing devices in the network.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a prior art computing environment;

FIG. 2 shows a general model of software defined security as disclosed herein;

FIG. 3 shows a block diagram of a network arrangement based on the model of FIG. 2;

FIG. 4 shows an enterprise deployment of an interconnected environment using the model of FIG. 2;

FIG. 5 shows different types of platforms on computing entities operable in an interconnected environment as in FIG. 4; and

FIG. 6 shows a flowchart of policy implementation in the environment of FIG. 5.

### DETAILED DESCRIPTION

Configurations depicted below present example embodiments of the disclosed approach in the form of a security manager which discovers the infrastructure network, deploys security containers, and continually monitors the security containers for response and effectiveness. In the network infrastructure, including computing entities adapted for running applications and network entities adapted for transporting data between the computing entities, security containers implement a method for protecting data. The network entities transport data in ingress to or egress from the computing entities, such as network interfaces cards (NIC) in the individual servers, routers, switches, and other devices primarily for data transport rather than computation.

A resource manager identifies a plurality of computing entities, such that each computing entity is operable for launch and execution of application entities on a particular platform. Each platform includes a server device and computing entities residing on the server device. Each computing entity includes at least one operating system and a capability to launch and execute at least one application entity. The platforms include hypervisors, containers and dedicated operating systems. Thus, a computing entity could be a dedicated machine with a single OS (Operating system), libraries/supporting files and application processes, or it could be a virtual machine or container sharing the same hardware.

The discussion below leverages distinctions between containers, VMs and dedicated operating systems (OSs). A container image is a lightweight, stand-alone, executable package of a piece of software that includes all necessary runtime aspects: code, runtime, system tools, system libraries, settings. It is stand-alone in that it may run on different OSs (i.e. Linux and Windows). Containerized software will always run the same, regardless of the environment. Containers isolate software from its surroundings, for example due to differences between development and staging environments, and help reduce conflicts between users running different software on the same infrastructure.

Containers and virtual machines have similar resource isolation and allocation benefits, but function differently because containers virtualize the operating system instead of hardware, and thus are more portable and efficient. Containers are therefore an abstraction at the app layer that packages code and dependencies together. Multiple containers can run on the same machine and share the OS kernel with other containers, each running as isolated processes in user space. Containers take up less space than VMs and start almost instantly

Virtual machines (VMs) are an abstraction of physical hardware, effectively transforming one server/machine into many servers. A hypervisor allows multiple VMs to run on a single machine. Each VM includes a full copy of an operating system, one or more apps, and necessary binaries and libraries, which tends to increase memory consumption. VMs can also be slow to boot.

In the disclosed approach, each server device (network entity) includes at least one physical processor, and memory coupled to the physical processor, such that the memory is responsive to application entities for execution thereon. The computing entities occupy physical memory in the corresponding server device. Each of the physical servers (server devices) interconnects to other servers via physical connections at some level, however virtualization of the machine (hypervisor) and of the operating system (container) blurs the distinction between computing and network entities.

Discovery includes identifying a set of network entities interconnecting the computing entities, such that the network entities and the platforms define the network infrastructure. The resource manager determines, for each of the computing entities, a manner of execution based on the platform, the server device and interconnected network entities. The resource manager then determines, based on the manner of execution of each of the computing entities, a security entity. Depending on the available resources, the determined security entity provides a best available security level for each computing entity. Some computing entities are virtual machines, of which several exist on a single server. The resource manager instantiates, on the server device of each platform, a security container for scrutinizing ingress and egress data for each of the computing entities on the platform. In this manner, the entire infrastructure is protected by the best available security according to the network police by deployment of the security containers.

Each deployed security container is operable to receive a security policy indicative of security logic for permitting data transport to and from the computing entity, and for identifying data flow to and from the computing entity. The security container applies the security logic to the identified data flow, and renders an event and remedial action based on the results of applying the security logic.

The disclosed approach takes note of the reality that each execution entity on which apps reside may not be a conventional dedicated OS and server. Rather, virtualization may separate the OS, machine and supporting libraries through the use of virtual machines and containers. The application entities launch in various manners of execution, such as through a hypervisor (VM with separate OS and address space), container (same OS, compartmentalized libraries) or a dedicated server (conventional OS and shared memory). The manner of execution is recognized by the resource manager in deploying the security container. Therefore, the method of enforcing network security as disclosed herein includes identifying a plurality of computing entities, each residing on a network entity, such that each network entity is adapted to launch and execute a network conversant app, and identifying a manner of execution of each of the computing entities, in which the manner of execution defines supporting resources employed in the execution (e.g. libraries, support files and OS).

The resource manager identifies, based on the manner of execution, a security entity (security container) corresponding to each identified computing entity, such that the security entity is operable to identify data associated with the computing entity. The resource manager includes logic for enforcing the network security policy. The resource manager is in communication with each of the security entities, and receives an indication of security entity operation. Each security entity evaluates the identified data upon ingress or egress to determine a security event, and communicates with the resource manager to provide consistent continued instantiation of the security entity.

As indicated above, the security entity is generally deployed based on best available security measures for the manner of execution. Depending on configuration, the security entity may be a container, or may be a hardware security module such as a security intelligent adapter, which replaces a conventional NIC in the server.

A container image, as used for the security container, is a lightweight, stand-alone, executable package of a piece of software that includes runtime support, i.e. code, runtime, system tools, system libraries, settings. Therefore, containerized software will always run the same, regardless of the environment. Containers isolate software from its surroundings, for example to accommodate differences between development and staging environments and help reduce conflicts between teams running different software on the same infrastructure.

Containers and virtual machines have similar resource isolation and allocation benefits, but function differently because containers virtualize the operating system instead of hardware, and are therefore more portable and efficient. Containers are an abstraction at the app layer that packages code and dependencies together. Multiple containers can run on the same machine and share the OS kernel with other containers, each running as isolated processes in user space. Containers take up less space than VMs (container images are typically smaller than VMs and start almost instantly. Virtual machines (VMs) are an abstraction of the conventional hardware, effectively turning one server into many virtual servers (VMs). The hypervisor allows multiple VMs to run on a single machine. Each VM includes a full copy of an operating system, one or more apps, necessary binaries and libraries—taking up tens of GBs. VMs can also be slow to boot.

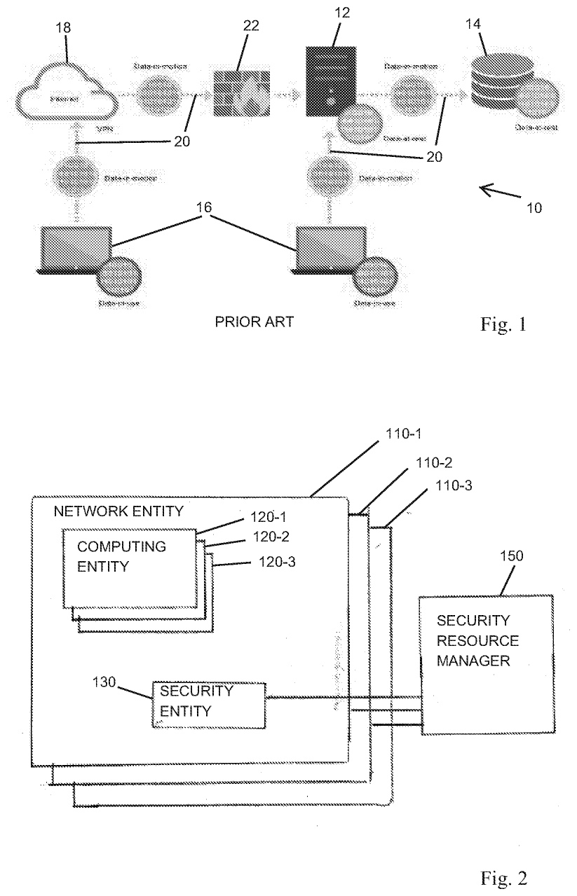

FIG. 1 is a context diagram of a prior art computing environment. Referring to FIG. 1, in a conventional network environment, network conversant computing devices, such as servers 12, storage devices 14, and user stations 16 interconnect via a public access network 18, such as the Internet and often referred to as “the cloud,” or dedicated local area networks (LAN)/wide area networks (WAN) and a series of links 20. The links convey data-in-motion between the network conversant devices, where it resides as data-at-rest in memory on a computing or storage device, or data-in-use as it is presented or input via a user input station 16 or device. Conventional security is provided by network interfaces upon ingress or egress from a computing device or network, using network interfaces, typically a network interface card (NIC), firewalls 22, and VPNs (Virtual Private Networks).

FIG. 2 shows a general model of software defined security as disclosed herein. Referring to FIG. 2, an organization, business or other entity maintains a network infrastructure for providing computer services to users who invoke the infrastructure for computing services. Users may be interconnected at various locations, in various manners. Some may be remote, connected via VPN (virtual private network) access, and others may be collocated on a LAN at a particular site or building. Each employs a network entity 110-1 . . . 110-3 (110 generally), which are physical devices such as a server, desktop, laptop or other informational device. The server devices include at least one physical processor, and memory coupled to the physical processor, such that the memory is responsive to software applications for execution thereon. Network entities also include connectivity devices, such as routers, switches, and related devices. Therefore, the network entities may transport data in ingress to or egress from the computing entities. In general, each network entity 110 in the infrastructure connects directly or indirectly with the other network entities 110 via wired or wireless links.

Each network entity 110 includes one or more computing entities 120-1 . . . 120-3 (120 generally). Computing entities 120 include various partitions and arrangements of software entities, such as processes running under a common OS (operating system), virtual machines (VMs) operating in a hypervisor, and containers (independent entities sharing an OS). The computing entity 120 includes at least one operating system and a capability to launch and execute at least one application entity, and occupies physical memory in the corresponding server device. A computing entity 120 is therefore capable of providing a user with impression of dedicated, interactive, computing services, even though the underlying network entity 110 may support other computing entities. Traditional approaches merge the concept of a network entity and computing entity, because each physical hardware “box” denotes a single computing entity with one OS and address space. Introduction of VMs and containers allows multiple computing entities 120 per physical network entity 110.

In the infrastructure, uniform deployment and enforcement of the network policy is sought. Each network entity 110 therefore has at least one security entity 130 for providing security to the computing entities relying on it. The security entity 130 may be a container, virtual machine or hardware structure coupled to the network entity 110 for providing security. Each security entity 130 is in communication with a security resource manager 150 for ensuring common, consistent deployment of security entities for implementing the policy infrastructure wide. In a particular configuration, the security resource manager 150 may be fulfilled by an SDS orchestrator for instantiating software controlled entities that define or manage the security entity 130.

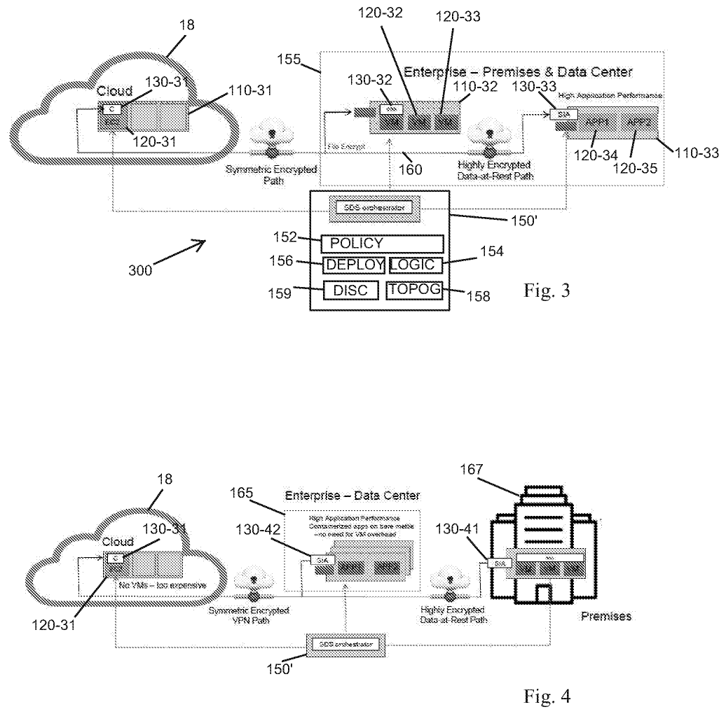

FIG. 3 shows a block diagram of a network arrangement based on the model of FIG. 2. Referring to FIGS. 2 and 3, the SDS orchestrator 150′ maintains the network security policy 152 including logic 154 for identifying and remedying security issues and events in the protected infrastructure 300. A discovery service 159 is configured to identify a plurality of computing entities 120 in the infrastructure 300, and a topography service 158 is configured to identify a set of network entities 110 interconnecting the computing entities 120. Deployment logic 156 is operable to determine, for each of the computing entities 120, the manner of execution based on the platform, the server device and interconnected network entities 110, and to determine, based on the manner of execution of each of the computing entities 120, an appropriate security entity 130, such that the determined security entity 130 provides a best available security level for the computing entity 110. This means that the deployment logic 156 determines if the manner of execution is a VM, container or dedicated OS, and then determines whether the security entity should be a container, VM or hardware based invocation.

In FIG. 3, a remote network entity 110-31 couples to an infrastructure network 160 via the public access network 18. A local site 155 includes a local network entity 110-32 and a network entity 110-33 designated as a central server for high performance.

The SDS orchestrator 150′ instantiates a security entity 130-31 defined by a container for a computing entity 120-31. The container is acceptable because the remote location likely does not have a huge demand, and the container will avoid the need for supporting libraries and files that may be at the local site 155.

At the local site 155, the network entity 110-32 is a hypervisor, and the SDS orchestrator 150′ deploys a security entity 130-32 defined by a virtual machine to cover the computing entities 120-32 and 120-33 (other virtual machines). The network entity 110-33 for high performance response, such as the data center or storage repository, employs a security entity 130-33 defined by a hardware interface card, or secure intelligent adaptor (SIA) which replaces the network card on the network entity 110-33. This provides higher performance to cover the computing entities 120-34, 120-35 at the data center.

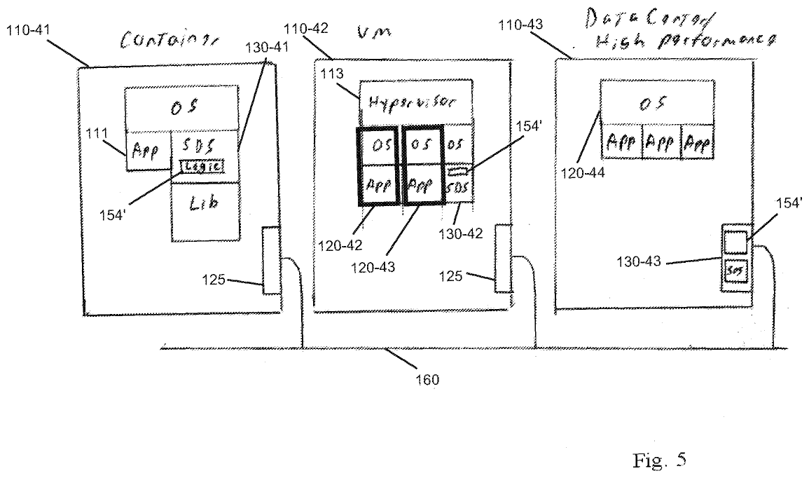

FIG. 4 shows an enterprise deployment of an interconnected environment using the model of FIG. 2. Referring to FIGS. 2-4, an enterprise may be hosted by an off-site data center computing support facility, such as for software as a service (SaaS) implementations, as shown in FIG. 4. This is similar to FIG. 3, except that the primary data center 165 is off site from the main business facility 167. In this arrangement, the security entity 130-42, 130-41 (respectively) for both the data center 165 and the business facility 167 is an SIA. Remote (cloud) users continue to operate using the container 130-31. The high computing intensity of the VMs at the business facility 167 is greater than the remote computing entity 120-31, thus the hardware performance of the SIA is called for by the business facility and the data center 165, but not necessarily for the remote user.

FIG. 5 shows different types of platforms on computing entities operable in an interconnected environment as in FIG. 4. Referring to FIGS. 3 and 5, the network entities 110-41, 110-42 and 110-43 support a container based approach, a VM based approach and a hardware (SIA) based approach, respectively. The infrastructure network 160 connects each computing entity for deploying security entities 130-41, 130-42 and 130-43. Each security entity 130 receives the security logic 154′ from the SDS orchestrator 150′ for implementing the policy 152. On computing entity 110-41, a dedicated OS launches and executes applications (apps) 111. A container, having self contained libraries and support files, defines the security entity 130-41, typically for monitoring an interface 125 for the network interconnection 160. A hypervisor 113 on the network entity 110-42 launches and executes computing entities 120-42, 120-43 defined by VMs. Although each has a dedicated OS and apps, the security entity 130-42 implements the logic 154′. On the data center network entity 110-43, high throughput and performance demands require a hardware implementation using the SIA as the security entity 130-43.

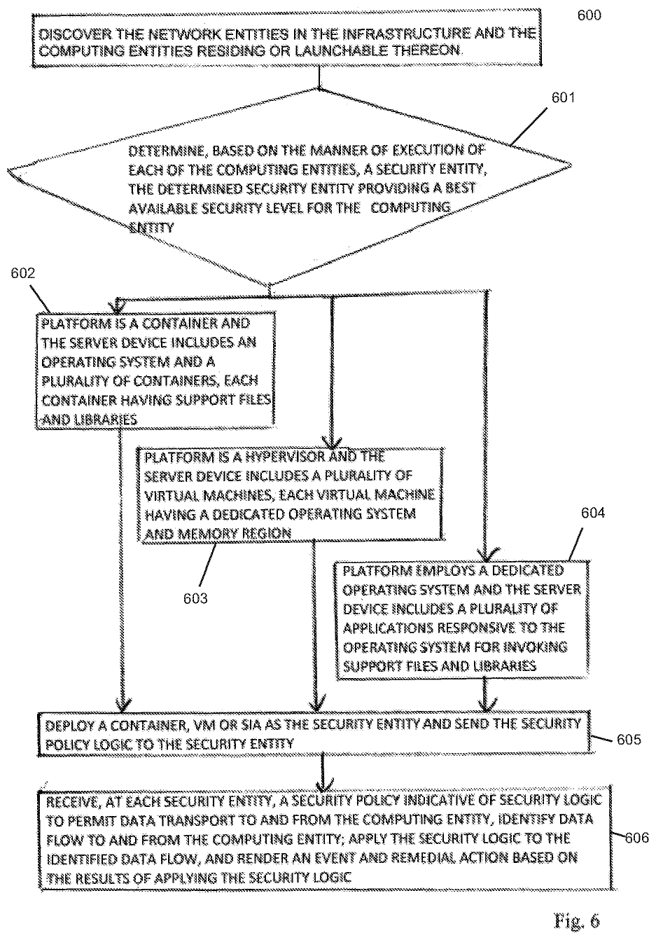

FIG. 6 shows a flowchart of security entity deployment in the infrastructure of FIGS. 3-5. Referring to FIG. 6, at step 600, the resource manager 150 (SDS orchestrator, in the example configuration) discovers the network entities 110 in the infrastructure and the computing entities 120 residing or launchable thereon. This includes identifying a plurality of computing entities 120, such that each computing entity 120 is operable for launch and execution of applications and having a platform. Platforms define the partitioning of executable entities in the computing entity, such as a dedicated OS, hypervisor, or container, or a combination of these. Each platform includes a server device, defined by the network entity 110 and executable computing entities residing on the server device. Discovery also include identifying the set of network entities 110 interconnecting the computing entities 120, in which the network entities 110 and the platforms defining the network infrastructure. In other words, the network entities 110 define the physical hardware elements (devices) in the infrastructure, including computing devices (servers, desktops, laptops, etc.) and data storage/transmission devices such as routers, switches, and disk drives/solid state devices for storage.

The SDS orchestrator 150′ determines, for each of the computing entities 120, a manner of execution based on the platform, the server device and interconnected network entities, and then determines, based on the manner of execution of each of the computing entities, a security entity for providing a best available security level for the computing entity, as depicted at step 601. As indicated above, the platform includes hypervisors, containers and dedicated operating systems. Based on the determination at step 601, If the platform supports containers, then the server device includes an operating system and a plurality of containers, such that each container has support files and libraries for independent execution, as shown at step 602.

If the platform is a hypervisor, then the server device includes a plurality of virtual machines, such that each virtual machine has a dedicated operating system and memory region, as shown at step 603. If the platform employs a dedicated operating system and the server device includes a plurality of applications responsive to the operating system for invoking support files and libraries, then a dedicated SIA as a NIC card may be the optimal deployment. Based on the determination at steps 602-604, the SDS orchestrator 150′ deploys a container, VM or SIA as the security entity, receives, and sends the security policy logic 154 to the security entity, as depicted at step 605

This includes instantiating or invoking, on the server device of each platform, a security entity 120 for scrutinizing ingress and egress data for each of the computing entities 120 on the platform. The security entity 120 is operable to receive the security policy 152 indicative of security logic 154 for permitting data transport to and from the computing entity, identify data flow to and from the computing entity, apply the security logic to the identified data flow, and render an event and remedial action based on the results of applying the security logic, as depicted at step 606. In the case of previously installed hardware, such as the SIA, the SDS orchestrator 150′ invokes and/or configures the SIA for implementation of the security policy.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a network infrastructure including computing entities adapted for running applications and network entities adapted for transporting data between the computing entities, a method for protecting data, comprising:
identifying a plurality of computing entities, each computing entity operable for launch and execution of application entities and having a platform, each platform including a server device and computing entities residing on the server device;
identifying a set of network entities interconnecting the computing entities, the network entities and the platforms defining the network infrastructure;
determining, for each of the computing entities, a manner of execution based on the platform, the server device and interconnected network entities;
determining, based on the manner of execution of each of the computing entities, a security entity, the determined security entity providing a best available security level for the computing entity; and
instantiating, on the server device of each platform, a security container for scrutinizing ingress and egress data for each of the computing entities on the platform.

2. The method of claim 1 wherein the computing entity includes at least one operating system and a capability to launch and execute at least one application entity.

3. The method of claim 1 wherein the platform includes hypervisors, containers and dedicated operating systems.

4. The method of claim 1 wherein the server device includes at least one physical processor, and memory coupled to the physical processor, the memory responsive to application entities for execution thereon.

5. The method of claim 4 wherein the computing entities occupy physical memory in the corresponding server device.

6. The method of claim 1 wherein the network entities transport data in ingress to or egress from the computing entities.

7. The method of claim 1 wherein the security container is operable to:
receive a security policy indicative of security logic for permitting data transport to and from the computing entity;
identify data flow to and from the computing entity;
apply the security logic to the identified data flow; and
render an event and remedial action based on the results of applying the security logic.

8. The method of claim 3 wherein the platform is a hypervisor and the server device includes a plurality of virtual machines, each virtual machine having a dedicated operating system and memory region.

9. The method of claim 3 wherein the platform is a container and the server device includes an operating system and a plurality of containers, each container having support files and libraries

10. The method of claim 3 wherein the platform is a dedicated operating system and the server device includes a plurality of applications responsive to the operating system for invoking support files and libraries.

11. A security resource manager device for a network infrastructure, the infrastructure including computing entities adapted for running applications and network entities adapted for transporting data between the computing entities, comprising:
a discovery service configured to identify a plurality of computing entities, each computing entity operable for launch and execution of application entities and having a platform, each platform including a server device and computing entities residing on the server device;
a topography service configured to identify a set of network entities interconnecting the computing entities, the network entities and the platforms defining the network infrastructure; and
deployment logic operable to determine, for each of the computing entities, a manner of execution based on the platform, the server device and interconnected network entities,
the deployment logic further operable to determine, based on the manner of execution of each of the computing entities, a security entity, the determined security entity providing a best available security level for the computing entity, and instantiate, on the server device of each platform, a security container for scrutinizing ingress and egress data for each of the computing entities on the platform.

12. The method of claim 11 wherein the computing entity includes at least one operating system and a capability to launch and execute at least one application entity.

13. The method of claim 11 wherein the platform includes hypervisors, containers and dedicated operating systems.

14. The method of claim 11 wherein the server device includes at least one physical processor, and memory coupled to the physical processor, the memory responsive to application entities for execution thereon; and the computing entities occupy physical memory in the corresponding server device.

15. The method of claim 11 wherein the network entities are configured to transport data in ingress to or egress from the computing entities.

16. The method of claim 11 wherein the security container is operable to:
receive a security policy indicative of security logic for permitting data transport to and from the computing entity;
identify data flow to and from the computing entity;
apply the security logic to the identified data flow; and
render an event and remedial action based on the results of applying the security logic.

17. The device of claim 13 wherein the platform is a hypervisor and the server device includes a plurality of virtual machines, each virtual machine having a dedicated operating system and memory region.

18. The device of claim 13 wherein the platform is a container and the server device includes an operating system and a plurality of containers, each container having support files and libraries

19. The device of claim 13 wherein the platform is a dedicated operating system and the server device includes a plurality of applications responsive to the operating system for invoking support files and libraries.

20. A computer program product on a non-transitory computer readable storage medium having instructions that, when executed by a processor, perform a method for protecting data, the method comprising:
identifying a plurality of computing entities, each computing entity operable for launch and execution of application entities and having a platform, each platform including a server device and computing entities residing on the server device;
identifying a set of network entities interconnecting the computing entities, the network entities and the platforms defining the network infrastructure;
determining, for each of the computing entities, a manner of execution based on the platform, the server device and interconnected network entities;
determining, based on the manner of execution of each of the computing entities, a security entity, the determined security entity providing a best available security level for the computing entity; and
instantiating, on the server device of each platform, a security container for scrutinizing ingress and egress data for each of the computing entities on the platform.
